(19) United States
(12) Patent Application Publication
(10) Pub. No.: US 2017/0206904 A1
(43) Pub. Date: Jul. 20, 2017

(54) CLASSIFYING SIGNALS USING FEATURE TRAJECTORIES

(71) Applicant: KnuEdge Incorporated, San Diego, CA (US)

(72) Inventors: Douglas Robert Bergman, San Diego, CA (US); John Clemente Quinn, San Diego, CA (US); David Carlson Bradley, San Diego, CA (US)

(73) Assignee: KnuEdge Incorporated, San Diego, CA (US)

(21) Appl. No.: 15/000,135

(22) Filed: Jan. 19, 2016

(51) Int. Cl. G10L 17/08; G10L 25/15; G10L 17/02

(52) U.S. Cl. CPC G10L 17/08; G10L 17/02; G10L 25/15

(57) ABSTRACT

An input signal may be classified by comparing a trajectory of a sequence of feature vectors of the input signal to sequences of feature vectors of reference signals, wherein the reference signals correspond to classes. For a class, a score may be computed that indicates a match between the trajectory of the input signal with trajectories of reference sequences corresponding to the class. The input signal may be classified by selecting a class corresponding to a highest score. In some implementations, the score may by computed by determining a number of nearest neighbors of the class to the input signal or by sequentially processing the input signal and updating a score for successive steps of the input sequence.

### BACKGROUND

Signal classification arises in a variety of applications. In signal classification, an input signal is received, and it is desired to determine to which of multiple classes the signal most likely belongs. For example, a simple classification task may be to automatically determine whether a received email is spam or is not spam. When an email is received, information about the email (e.g. the text of the email, the sender, an internet protocol address of the sender) may be processed using algorithms and models to classify the email as spam or as not spam.

Another example of signal classification relates to determining the identity of a speaker. A class may exist for each speaker of a set of speakers, and a model for each class may be created by processing speech samples of each speaker. To perform classification, a received speech signal may be compared to models for each class. The received signal may be assigned to a class based on a best match between the received signal and the class models.

In some instances, it may be desired to verify the identity of a speaker. A speaker may assert his identity (e.g., by providing a user name) and a speech sample. A model for the asserted identity may be obtained, and the received speech signal may be compared to the model. The classification task may be to determine whether the speech sample corresponds to the asserted identity.

In some instances, it may be desired to determine the identity of an unknown speaker using a speech sample of the unknown speaker. The speaker may be unknown, but it may be likely that the speaker is of a known set of speakers (e.g., the members of a household). The speech sample may be compared to models for each class (e.g., a model for each person in the household), and the classification task may be to determine which class best matches the speech sample or that no class matches the speech sample.

When performing signal classification, it is desired that the signal classification techniques have a low error rate, and the signal classification techniques described herein may have lower error rates than existing techniques.

### BRIEF DESCRIPTION OF THE FIGURES

The invention and the following detailed description of certain embodiments thereof may be understood by reference to the following figures:

FIG. 1 illustrates a system for performing classification using trajectories.

FIG. 2 is a flowchart of an example implementation of performing classification using trajectories.

FIGS. 3A and 3B illustrate example trajectories of six reference signals and one input signal.

FIG. 4 illustrates segmentation of a sequence.

FIG. 5 illustrates a graph for alignment of a reference sequence with an input sequence.

FIG. 6 illustrates alignment of a reference sequence with an input sequence.

FIG. 7 illustrates feature vectors of reference sequences and an input sequence in a feature space.

FIG. 8 illustrates reference sequences with missing feature vectors.

FIG. 9 is a flowchart showing an example implementation of performing classification using nearest neighbors.

### DETAILED DESCRIPTION

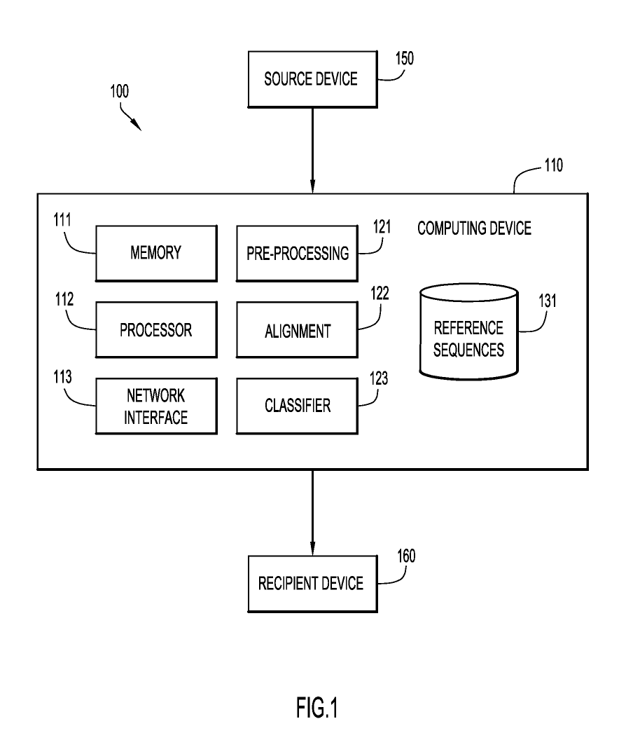

Described herein are techniques for performing classification of signals, and FIG. 1 shows an example of a system 100 that may be used for classifying signals. System 100 may include a source device 150 that is providing a signal to be classified. For example, source device 150 may have a microphone and may provide an audio signal for classification. Computing device 110 may be any device that performs classification techniques on an input signal. For example, computing device 110 may be a server computer that is configured to receive signals, classify them, and output a result of the classification. Recipient device 160 may be any device that receives the results of the classification.

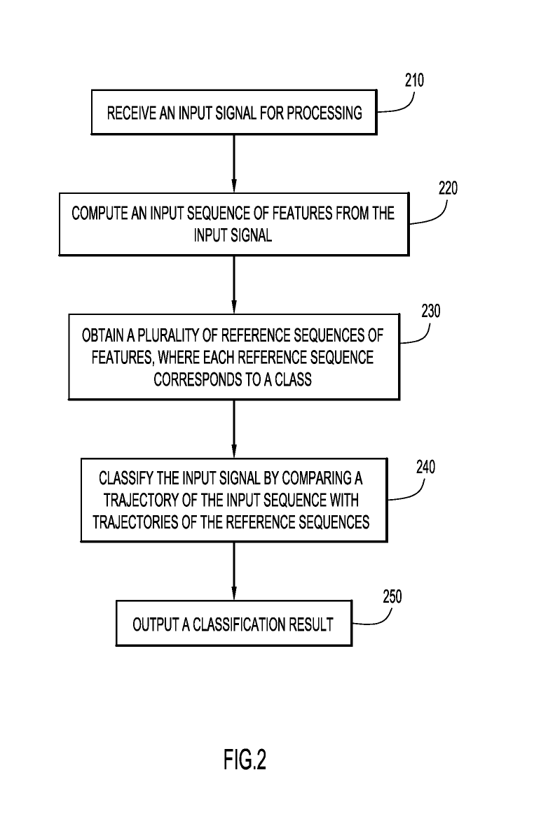

Computing device 110 may, in some implementations, perform classification as described by the flow chart of FIG. 2. At step 210, computing device 110 receives an input signal for processing. The input signal may be any signal for which classification is desired, and may be, for example, a one-dimensional signal (e.g., an audio signal or speech), a two-dimensional signal (e.g., an image), or a three-dimensional signal (e.g., video). In the following, speaker classification will be used as an example classification task for clarity of explanation, but the techniques described herein are not limited to one-dimensional signals, not limited to speaker classification, and may be used with any suitable classification task.

At step 220, a sequence of input features is computed from the input signal. Each item in the sequence may be a single feature or multiple features, such as a feature vector. In the description below, a sequence of feature vectors will be used as an example, but the sequence of features need not necessarily be a sequence of feature vectors. Each item of the sequence may be referred to as a step of the sequence. In some implementations, computing the sequence of feature vectors may comprise computing feature vectors at regular time intervals, such as every 10 milliseconds (for higher dimensional input signals the sequence may comprise moving in any suitable dimension).

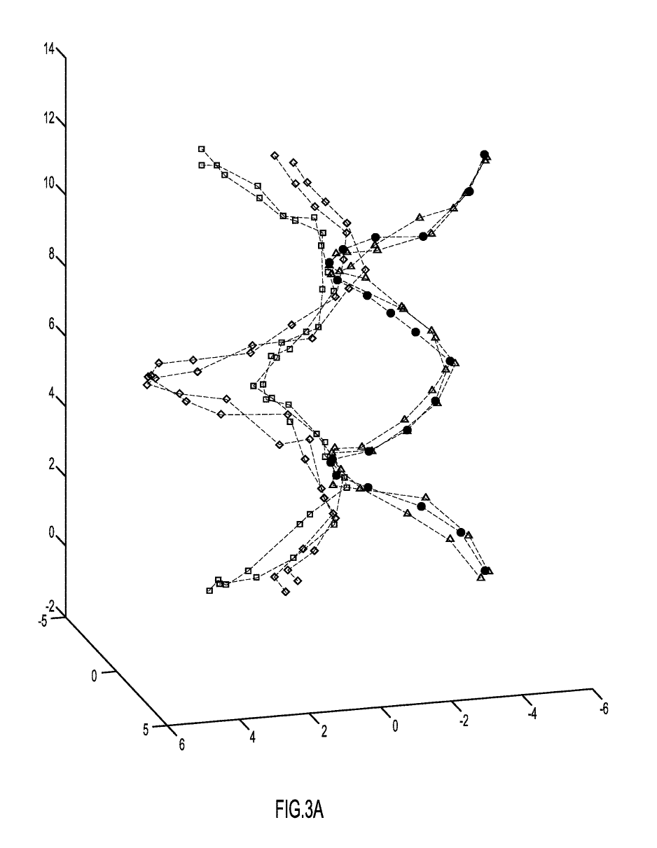

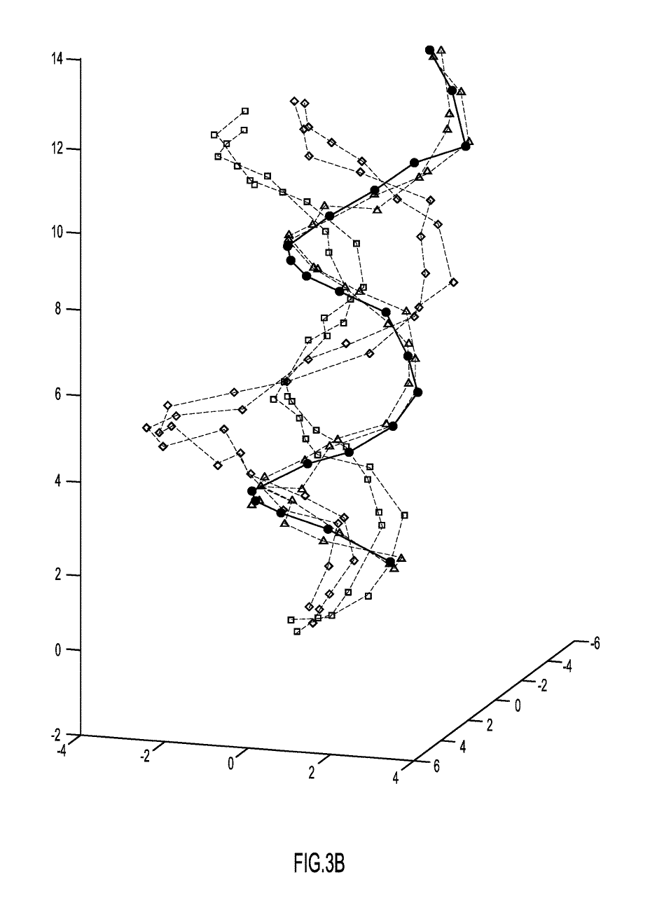

For an audio signal, a feature vector may comprise harmonic amplitudes, mel-frequency cepstral coefficients, or any other suitable features. As an example, a feature vector of harmonic amplitudes may include an estimate of an amplitude of each harmonic in a portion of a signal. For a portion of the audio signal, harmonic amplitudes may be computed as follows: (i) estimate a pitch of the portion of the signal (optionally using a fractional chirp rate); (ii) estimate an amplitude of each harmonic of the portion of the signal where the first harmonic is at the pitch, the second harmonic is at twice the pitch, and so forth; and (iii) construct a vector of the estimated amplitudes. Each harmonic amplitude vector may be represented as a point in an n-dimensional space (e.g., as shown in FIGS. 3A and 3B). A vector of harmonic amplitudes may similarly be constructed for successive portions of an audio signal, such as every 10 milliseconds. Additional details regarding the computation of harmonic amplitude features are described in U.S. application Ser. No. 14/969,029, filed on Dec. 15, 2015, and titled “Determining Features of Harmonic Signals,” the entire contents of which are hereby incorporated by reference for all purposes.

At step 230, a plurality of reference sequences of features is obtained where each reference sequence corresponds to a class. The number and type of classes may depend on a particular classification task. For example, for speaker classification, a class may exist for each known speaker. Each class may have one or more reference sequences. For example, for a speaker classification task, a speaker may be required to provide several examples of speaking a specific phrase, such as “knock knock who's there.” The several examples of how a single speaker speaks the phrase may provide information about variability in the speaker's voice. A reference sequence of features may be created for each recording of the phrase. The reference sequences of features may comprise the same type of features as used for the input sequence.

FIGS. 3A and 3B illustrate an input sequence and reference sequences for a speaker classification task with three known speakers. In FIGS. 3A and 3B, the horizontal axes represent two dimensions of a feature vector used for speaker classification. Although speaker classification feature vectors generally have anywhere from 10 to 30 or more dimensions, only two dimensions are shown for clarity of presentation.

In FIGS. 3A and 3B, the vertical axis corresponds to the sequence of feature vectors over time. The input sequence is shown by black circles. The reference sequences include two reference sequences for each of three speakers. Two reference sequences for a first speaker are shown with square markers, two reference sequences for a second speaker are shown with diamond markers, and two reference sequences for a third speaker are shown with triangular markers. FIGS. 3A and 3B represent the same data shown from two different angles.

At step 240, the input signal is classified by comparing a trajectory of the input sequence with the trajectories of the reference sequences in a multi-dimensional space. A trajectory of a sequence of features is the path of the sequence trough the multi-dimensional space. The trajectories may be compared using any suitable techniques, including any of the techniques described below. For example, a score (such as a probability measure, likelihood, or a metric) may be computed that measures similarity (e.g., a distance) of the input sequence to the reference sequences of each class, and the input signal may be classified by selecting a highest (or, depending on the implementation, a lowest) score. In some implementations, the reference sequences may be aligned with the input sequence (described in greater detail below) prior to comparing trajectories. For example, with a speaker classification task, it may be desired to remove the effect of different speaking rates and/or pauses in speech. As can be seen in FIGS. 3A and 3B, the input sequence is a best match to the third speaker (with the triangular markers).

At step 250, a classification result is output. For example, the result may be the most likely class of the input signal and may include other statistics such as a probability measure or a confidence interval. The classification result may be output to recipient device 160.

Other configurations of source device, 150, computing device 110, and recipient device 160 are possible. In some implementations, source device 150, computing device 110, and recipient device 160 may all be the same device. For example, a user could speak to a personal device to unlock the device with speaker verification, and the personal device may capture an audio signal, perform classification on the audio signal, and then use the results of the classification to decide whether to unlock the device.

FIG. 1 illustrates components of one implementation of computing device 110 for implementing classification as described herein. In FIG. 1, the components are shown as being on a single computing device, but the components may be distributed among multiple computing devices, such as a system of computing devices, including, for example, an end-user computing device (e.g., a smart phone or a tablet) and/or a server computing device (e.g., cloud computing).

Computing device 110 may include any components typical of a computing device, such as volatile or nonvolatile memory 111, one or more processors 112, and one or more network interfaces 113 (e.g., for communicating with source device 150 or recipient device 160). Computing device 110 may also include any input and output components, such as displays, keyboards, and touch screens. Computing device 100 may also include a variety of components or modules providing specific functionality, and these components or modules may be implemented in software, hardware, or a combination thereof. For example, computing device 110 may have a pre-processing component 121 for performing any needed operations on an input signal, such as segmentation, analog-to-digital conversion, encoding, or decoding. Computing device 110 may have an alignment component 122 that aligns reference sequences to an input sequence. Computing device 110 may also have a classification component 123 that classifies an input signal by comparing a trajectory of the input signal with trajectories of reference signals. Computing device 110 may have or may have access to a database of reference sequences 131 to be used in performing classification. It should be noted that although the pre-processing component 121, alignment component 122 and classification component 123 are shown in separate boxes on FIG. 1, in some embodiments, some or all functionalities of these components may be implemented as software, for example, computer instructions stored in memory 111 and executed by the processor 112.

Further details of the above techniques are now described, including segmentation of input signals, alignment of reference sequences with an input sequence, and additional details of classification.

In some implementations, the input signal may be processed before computing the input sequence of features. For example, where the input signal is an audio signal, it may be desired to remove portions of the audio signal before computing features. Portions that may be removed may include any of the following: portions that do not comprise speech, portions with significant noise, portions with a low signal-to-noise ratio, or portions corresponding to certain types of speech (e.g., it may be desired to remove unvoiced speech and compute features only for voiced speech). Any suitable techniques may be used to identify portions of an input signal to be removed. For other types of input signals (e.g., non-audio signals), less useful or less desirable portions may be similarly removed before computing features. The process of removing portions of the input signal may be referred to as segmentation and the result of segmentation may be referred to as a segmented input signal.

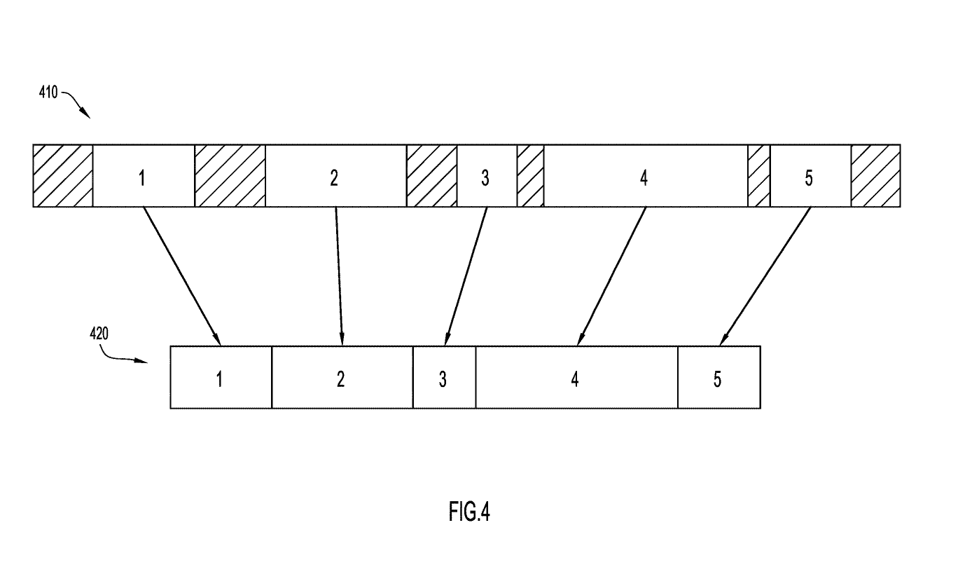

FIG. 4 illustrates an example of removing portions of an input signal. In FIG. 4, an input signal 410 is shown, where the signal is progressing from left to right. For example, for an audio signal, input signal 410 may correspond to a sequence of feature vectors with the first feature vector on the left and the last feature vector on the right. In input signal 410, the gray areas represent portions to be removed, and the white portions (numbered 1 to 5) represent portions to be retained. For example, where the input signal is an audio signal, the gray portions may correspond to gaps between words or speech and the white portions may correspond to speech to be processed. In FIG. 4, segmented signal 420 is shown where the gray portions have been removed and the five white portions have been retained and moved to be adjacent to one another.

The segmentation process may be performed before or after computing a sequence of features from the input signal. For example, where the input signal is an audio signal, the segmentation may be performed on a time-series representation of the audio signal and the sequence of features may be computed from the segmented time-series signal. Alternatively, a sequence of features may be computed for the entire input signal, and the segmentation process may remove features from the sequence of features.

The above segmentation process may also be performed on a reference signal when computing a reference sequence of features. It may be desired to segment a reference signal for the same reasons as for segmenting an input signal. For example, for a reference signal that is an audio signal, it may be desired to remove silence from the reference signal when computing the reference sequence of features.

Other processing that may be performed includes aligning a reference sequence of features with an input sequence of features. Alignment may allow for a more accurate comparison of the input sequence of features with a reference sequence of features. For example, the alignment process may remove undesired differences due to scale, due to a speeding up or slowing down of a signal in time, or due to unexpected or undesired deviations in the input sequence or a reference sequence.

For example, consider classification of a speaker. The input signal and each reference signal may correspond to a person speaking a phrase, such as “knock knock who's there.” Different speakers may have different speaking rates or a single speaker may speak with a different speaking rate at different times. Speakers may also deviate from the fixed phrase, for example by stuttering (“knock kn-knock who's there”), saying different words (“knock knock who is there”), or leaving out words or portions of words (“knock who's there”). In some implementations, it may be desired to remove differences due to speaking rates and due to unintended or unexpected deviations in an input sequence or a reference sequence.

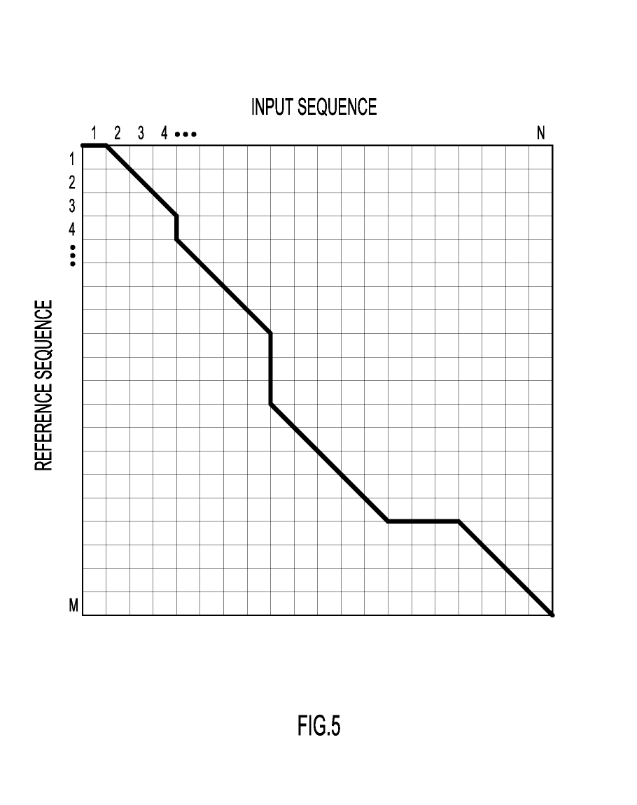

The alignment of a reference sequence of features with an input sequence of features may be performed using any suitable techniques. For example, the sequences may be aligned using an alignment graph, such as using Dijkstra's algorithm with an alignment graph. FIG. 5 illustrates an example of an alignment graph that may be used to align a reference sequence with an input sequence. In FIG. 5, an input sequence of N feature vectors is shown along the top of the graph and a reference sequence of M feature vectors is shown along the left side of the graph. M and N may have the same value or different values.

To align the reference sequence with the input sequence, a distance (or some other metric) between the feature vectors of the input sequence and the feature vectors of the input sequence may be computed. In some implementations, all possible distances may be computed (e.g., N times M total distances) and in other implementations fewer distances may be computed (e.g., by using dynamic programming algorithms). Any appropriate distance (or other similarity metric) may be used, such as a Euclidean distance, a measure of information, or an estimate of probabilistic likelihood. An alignment of a reference sequence with an input sequence may be chosen that maximizes similarity between feature vectors of the reference sequence and feature vectors of the input sequence, such as by minimizing aggregate distance, or by optimizing the chosen metric appropriately.

In performing an alignment, there may be feature vectors of the reference sequence that do not match any feature vectors of the input sequence and vice versa. For example, if the reference sequence corresponds to “knock knock who's there” and the input sequence has a stutter (“kn-knock”) then the feature vectors of the stutter in the input sequence may not match any feature vectors of the reference sequence. Depending on the frame of reference, this may be referred to as an “insertion” in the input sequence or a “deletion” in the reference sequence.

In the example of FIG. 5, the thick line corresponds to a best match between the reference sequence and the input sequence. In FIG. 5, when the dark line is horizontal, the corresponding feature of the input sequence is not aligned with any feature vector of the reference sequence (this may be referred to as an “excursion” in the input sequence). When the dark line is vertical, the corresponding vector of the reference sequence is not aligned with any vector of the input sequence (this may be referred to as an “excursion” in the reference sequence). When the dark line is diagonal, the corresponding feature vector of the reference sequence has been aligned with the corresponding feature vector of the input sequence. For example, in FIG. 5, input feature vector 1 is not aligned with any reference feature vector, reference feature vectors 1-3 are aligned with input feature vectors 2-4, reference feature vector 4 is not aligned with any input feature vector, and so forth.

In determining a best alignment, a path is determined from the top-left corner of the graph (corresponding to the beginnings of the sequences) to the bottom-right corner of graph (corresponding to the ends of the sequences). This path may optimize an overall similarity function of the path, such as by minimizing an average or a total distance, maximizing total joint likelihood, or maximizing a measure of mutual information.

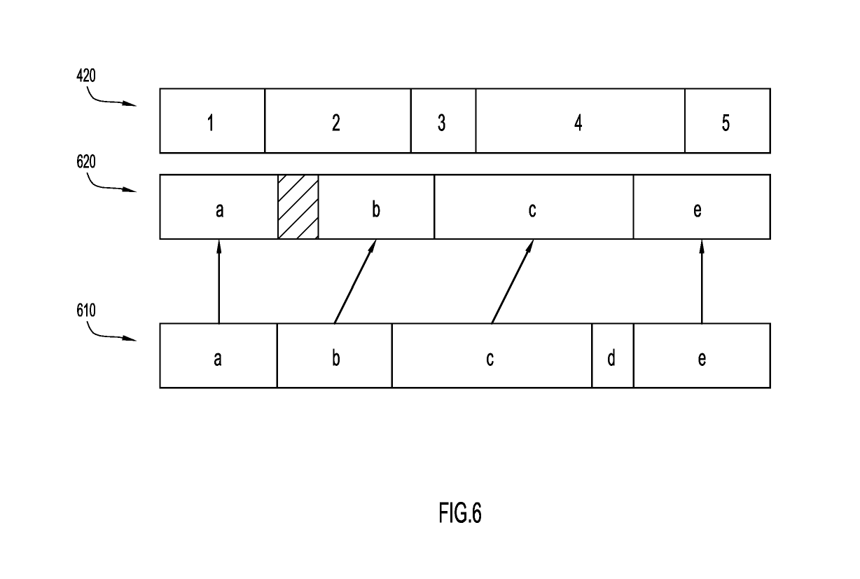

FIG. 6 illustrates a result of aligning a reference sequence with an input sequence. In FIG. 6, segmented input sequence 420 is the same as from FIG. 4. In FIG. 6, a reference sequence 610 is shown. Reference sequence 610 may have already been segmented (although segmentation of the reference sequence is not required), and portions of reference sequence 610 are labeled with the letters “a” to “e.” In FIG. 6, an aligned reference sequence 620 is shown. In aligned reference sequence 620, portion a is aligned with portion 1 and part of portion 2 of segmented input sequence 420. The gray portion of aligned reference sequence 620 indicates that there are no reference feature vectors that are aligned with the corresponding portion of segmented input sequence 420 and indicating an excursion in segmented input sequence 420. Portion b of aligned reference sequence 620 is aligned with part of portion 2 and part of portion 3 of segmented input sequence 420. Portion c of aligned reference sequence 620 is aligned with part of portion 3 and part of portion 4 of segmented input sequence 420. Portion d of reference sequence 610 is not aligned with any portion of segmented input sequence 420 and indicates an excursion in reference sequence 610. Portion e of aligned reference sequence 620 is aligned with part of portion 4 and portion 5 of segmented input sequence 420. Accordingly, FIG. 6 illustrates an alignment of the feature vectors of reference sequence 610 with the feature vectors of segmented input sequence 420.

The above alignment process may be performed for each reference sequence of a collection of reference sequences (e.g., for speaker recognition, the collection many include several reference sequences for each known speaker) so that each reference sequence is aligned with a received input sequence. After the reference sequences have been aligned, the trajectory of the input sequence may be compared with the trajectories of the reference sequences to perform classification of the input sequence.

Several variations of a trajectory classifier are described below with increasing complexity. For clarity of explanation, the initial description will assume that there are no excursions (in either the reference sequences or the input sequence). Afterwards, excursions will be addressed. Note that alignment is not required when performing classification and that classification may be performed using aligned or unaligned reference sequences.

In some implementations, a trajectory classifier may be implemented as a sequential process. Suppose we have J classes, and denote each class as ωⱼ for j between 1 and J. Each class may have a prior probability that the input sequence is a member of the class, and this prior probability may be specified as Pr(ωⱼ) for j between 1 and J. In some implementations, there are no prior probabilities for the classes or the classes are assumed to have equal probabilities and Pr(ωⱼ) is not used (or have equal values). Given a first feature vector of an input sequence, x₁, the probability that the input sequence corresponds to class j may be specified as Pr(ωⱼ|x₁) and this probability may be determined using Pr(ωⱼ). Given the second feature vector of an input sequence, x₂, the probability that the input sequence corresponds to class j may be specified as Pr(ωⱼ|x₁, x₂) and this probability may be determined using Pr(ωⱼ|x₁). More generally, given the first t feature vectors of the input sequence, the probability that the input sequence corresponds to class j may be specified as Pr(ωⱼ|xᵢ, . . . , xₜ₋₁, xₜ) and this probability may be determined using Pr(ωⱼ|x₁, . . . , xₜ₋₁). The probability Pr(ωⱼ|x₁, . . . , xₜ₋₁, xₜ) may be referred to as a posterior probability.

The probability that the input sequence is a member of a class may further be determined using a probability density estimation procedure. One such procedure involves identifying nearest neighbors of the input sequence for each feature vector in the input sequence among the feature vectors in the set of reference sequences. Consider the sequence of feature vectors in FIG. 3A. At each step in the sequence, there is one input feature vector, and two reference feature vectors for each of three classes (assuming no excursions). Thus, at each step of the sequence, an input feature vector will have 6 neighbors. From the 6 neighbors, a subset of the 6 will be selected as nearest neighbors. In some implementations, the nearest neighbors may be determined by determining an n-sphere (a sphere in n dimensions) centered at the input feature vector and with a specified radius. The reference feature vectors within the n-sphere are the nearest neighbors to the input feature vector. The techniques described herein are not limited to using an n-sphere to determine nearest neighbors, and any appropriate techniques may be used to determine the nearest neighbors, including, for example, using ellipses or other distance measures for determining nearest neighbors.

The radius of the n-sphere may be determined using any appropriate techniques. In some implementations, the radius of the sphere may be specified using distances between the input feature vector and reference feature vectors (among all classes). For example, for a specified parameter k, the radius may be set to the distance between the input feature vector and the k^{th} closest reference feature vector. For example, if k is two, the radius may be set to the distance between the input feature vector and the second closest reference feature vector to the input feature vector. The number k may be chosen using any appropriate techniques. In some implementations, k may be selected as one less than the smaller of the total number of reference feature vectors and a specified maximum number.

In some implementations, probability densities may be determined using other density estimation procedures, such as using a joint Gaussian distribution or an information-based approach.

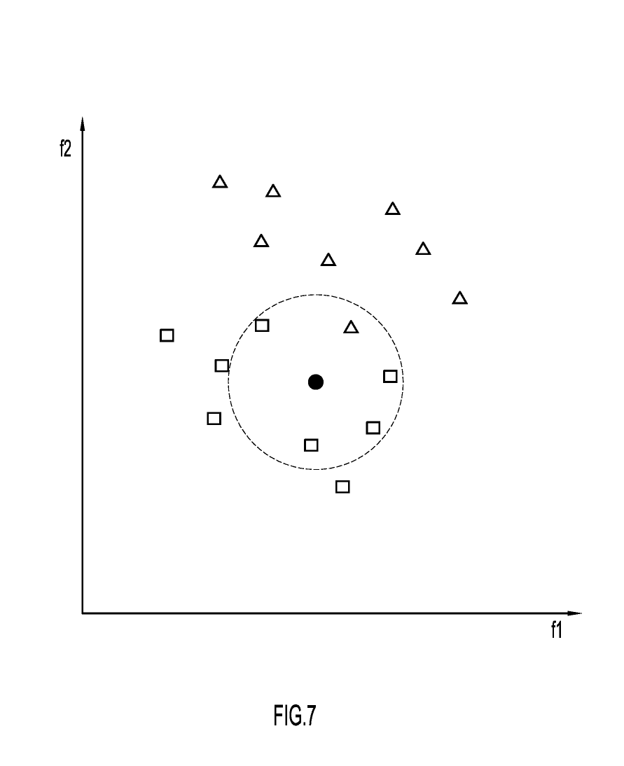

FIG. 7 illustrates, for one step of the sequence, nearest neighbors of an input feature vector for two dimensions of the feature vector (f1 and f2). FIG. 7 illustrates the location of the input feature vector and 8 feature vectors of a first class (represented by squares) and 8 feature vectors of a second class (represented by triangles). The n-sphere is illustrated by a dashed circle. There are 5 feature vectors within the n-sphere, and accordingly there are 5 nearest neighbors to the input feature vector at this step of the sequence. At other steps of the sequence, the radius of the n-sphere may be different and/or the number of nearest neighbors may be different.

Nearest neighbors may be used in a variety of ways when performing classification. In the following, several non-limiting examples will be provided for using nearest neighbors when performing classification, but the techniques described herein are not limited to these specific examples, and other implementations are possible.

The following equation gives one example of using nearest neighbors to determine a probability that an input sequence is a member of class j:

$$Pr ( {ω}_{j} \vert {x}_{1} , … , {x}_{t - 1} , {x}_{t} ) = \{ \begin{matrix}\frac{( \frac{{k}_{j , 1} + 1}{{R}_{j} + 2} ) Pr ( {ω}_{j} )}{{\sum }_{i = 1}^{J} ( \frac{{k}_{i , 1} + 1}{{R}_{i} + 2} ) Pr ( {ω}_{i} )} , & t = 1 \\ \frac{( \frac{{k}_{j , t} + 1}{{R}_{j} + 2} ) Pr ( {ω}_{j} \vert {x}_{1} , … , {x}_{t - 1} )}{{\sum }_{i = 1}^{J} ( \frac{{k}_{i , t} + 1}{{R}_{i} + 2} ) Pr ( {ω}_{i} \vert {x}_{1} , … , {x}_{t - 1} )} , & t = 2 , … , T\end{matrix}$$

In this equation, T is the total number of steps in the input sequence, R₁ indicates the number of reference sequences for class j, and k_{j,t} indicates the number of reference sequences of class j that are nearest neighbors to the input feature vector at step t.

The probability that the input sequence is a member of class j is determined using the following ratio

$$\frac{{k}_{j , t} + 1}{{R}_{j} + 2}$$

for each step t. This ratio has its highest value when all of the nearest neighbors of the input feature vector at step t are members of class j. The ratio has its lowest value when none of the reference sequences of class j are among the nearest neighbors to the input feature vector at step t. For the example of FIG. 7, the square class has 4 nearest neighbors and 8 total feature vectors so the ratio is (4+1)/(8+2) or 5/9, and the triangle class has 1 nearest neighbor and 8 total feature vectors so the ratio is (1+1)/(8+2) or 2/9.

In some implementations, nearest neighbors may be determined using two steps of the sequences simultaneously. Let xₜ represent an input feature vector at step t and xₜ₋₁ represent an input feature vector at step t−1. An augmented input feature vector for step t may be constructed by concatenating xₜ₋₁ and xₜ. The augmented input feature vector at step t may be denoted as Xₜ. Where each of xₜ₋₁ and xₜ are length N, Xₜ will have length 2N. Similarly, augmented reference vectors may be constructed from reference sequences. Let aₜ represent a feature vector of a reference sequence at step t and let aₜ₋₁ represent a feature vector of the same reference sequence at step t−1. An augmented reference feature vector for step t may be constructed by concatenating aₜ₋₁ and aₜ. The augmented reference feature vector at step t may be denoted as Aₜ. Where each of aₜ₋₁ and aₜ are length N, Aₜ will have length 2N. Determining nearest neighbors for augmented feature vectors may be performed in a similar manner as determining nearest neighbors for unaugmented feature vectors.

Any number of feature vectors may be used to create augmented feature vectors. The number of feature vectors in an augmented feature vector may be specified by M, and such augmented feature vectors may be referred to as M^{th}-order augmented feature vectors. For example, a second-order augmented feature vector at step t may be constructed from the feature vectors at steps t and t−1, and a third-order augmented feature vector at step t may be constructed from the feature vectors at steps t, t−1, and t−2.

The following equation gives an example of using nearest neighbors with second-order augmented feature vectors to determine a probability that an input sequence is a member of class j:

$$Pr ( {ω}_{j} \vert {x}_{1} , … , {x}_{t - 1} , {x}_{t} ) = \{ \begin{matrix}\frac{( \frac{{k}_{j , 1} + 1}{{R}_{j} + 2} ) Pr ( {ω}_{j} )}{{\sum }_{i = 1}^{J} ( \frac{{k}_{i , 1} + 1}{{R}_{i} + 2} ) Pr ( {ω}_{i} )} , & t = 1 \\ \frac{( \frac{{K}_{j , t} + 1}{{k}_{j , t - 1} + 2} ) Pr ( {ω}_{j} \vert {x}_{1} , … , {x}_{t - 1} )}{{\sum }_{i = 1}^{J} ( \frac{{K}_{i , t} + 1}{{k}_{i , t - 1} + 2} ) Pr ( {ω}_{i} \vert {x}_{1} , … , {x}_{t - 1} )} , & t = 2 , … , T\end{matrix}$$

In this equation, T, R₁ and k_{j,t} have the same meanings as above. Further, in this equation, K_{j,t} indicates a number of nearest neighbors using second-order augmented feature vectors. In particular, K_{j,t} indicates a number of second-order augmented feature vectors for class j at step t that are nearest neighbors to the second-order augmented input vector at step t.

At the first step (t=1), augmented feature vectors are not used since there are no previous feature vectors available to create augmented features. For later steps, the probabilities are determined using the following ratio:

$$\frac{{K}_{j , t} + 1}{{k}_{j , t - 1} + 2}$$

for each step t. The numerator of this ratio uses the number of second-order augmented reference feature vectors of class j that are nearest neighbors to the augmented input feature vector at step t. The denominator uses the number of unaugmented reference feature vectors of class j that are nearest neighbors to the unaugmented input feature vector at time t−1. This ratio represents the local probability density of class j reference feature vectors in a neighborhood about the input feature vector at time step t, given the proximity of those vectors to the input feature vector at time step t−1. This ensures that the density estimation of class j vectors at the location of the input feature vector is conditional on the historic path of the input feature vector prior to that time step. This provides an estimate of the similarity of the entire input feature path through the vector space to each class of reference feature paths, rather than the similarity of individual input feature vectors to a static series of vectors clustered in space.

More generally, the following equation gives an example of using nearest neighbors with M^{th}-order augmented feature vectors to determine a probability that an input sequence is a member of class j:

$$Pr ( {ω}_{j} \vert {x}_{1} , … , {x}_{t - 1} , {x}_{t} ) = \{ \begin{matrix}\frac{( \frac{{k}_{j , 1} + 1}{{R}_{j} + 2} ) Pr ( {ω}_{j} )}{{\sum }_{i - 1}^{J} ( \frac{{k}_{i , 1} + 1}{{R}_{i} + 2} ) Pr ( {ω}_{i} )} , & t = 1 \\ \frac{( \frac{{K}_{j , t}^{t} + 1}{{K}_{j , t - 1}^{t - 1} + 2} ) Pr ( {ω}_{j} \vert {x}_{1} , … , {x}_{t - 1} )}{{\sum }_{i = 1}^{J} ( \frac{{K}_{i , t}^{t} + 1}{{K}_{i , t - 1}^{t - 1} + 2} ) Pr ( {ω}_{i} \vert {x}_{1} , … , {x}_{t - 1} )} , & t = 2 , … , M - 1 \\ \frac{( \frac{{K}_{j , t}^{M} + 1}{{K}_{j , t - 1}^{M - 1} + 2} ) Pr ( {ω}_{j} \vert {x}_{1} , … , {x}_{t - 1} )}{{\sum }_{i = 1}^{J} ( \frac{{K}_{i , t}^{M} + 1}{{K}_{i , t - 1}^{M - 1} + 2} ) Pr ( {ω}_{i} \vert {x}_{1} , … , {x}_{t - 1} )} , & t = M , … , T\end{matrix}$$

In this equation, T, R₁ and k_{j,t} have the same meanings as above. Further, in this equation, K_{j,t}^{M} is a generalization K_{j,t} to other orders of augmented feature vectors. K_{j,t}^{M} indicates a number of nearest neighbors using M^{th}-order augmented feature vectors. In particular, K_{j,t}^{M} indicates a number of M^{th}-order augmented feature vectors for class j at step t that are nearest neighbors to the M^{th}-order augmented input vector at step t.

As in the previous example, augmented vectors are not used at the first step (t=1). For step 2 to step M−1, augmented feature vectors are used but the order of the augmented feature vectors is reduced. At step M, enough previous steps are available to use M^{th}-order augmented feature vectors in the computations. At step M and later steps, the probabilities are determined using the following ratio:

$$\frac{{K}_{i , t}^{M} + 1}{{K}_{i , t - 1}^{M - 1} + 2}$$

for each step t. The numerator of this ratio uses the number of M^{th}-order augmented reference feature vectors of class j that are nearest neighbors to the augmented input feature vector at step t. The denominator uses the number of (M−1)^{th}-order augmented reference feature vectors of class j that are nearest neighbors to the (M−1)^{th}-order augmented input feature vector at time t−1.

The above computations may be performed for each class. For example, where there are J classes, Pr(ωⱼ|x₁, . . . , xₜ₋₁, xₜ) may be computed for each value of j from 1 to J. The input signal may be classified by selecting a class corresponding to a highest probability.

The techniques described above have not explicitly accounted for the possibility of excursions in the input sequence or reference sequences. When there are excursions, the computations may be modified as follows.

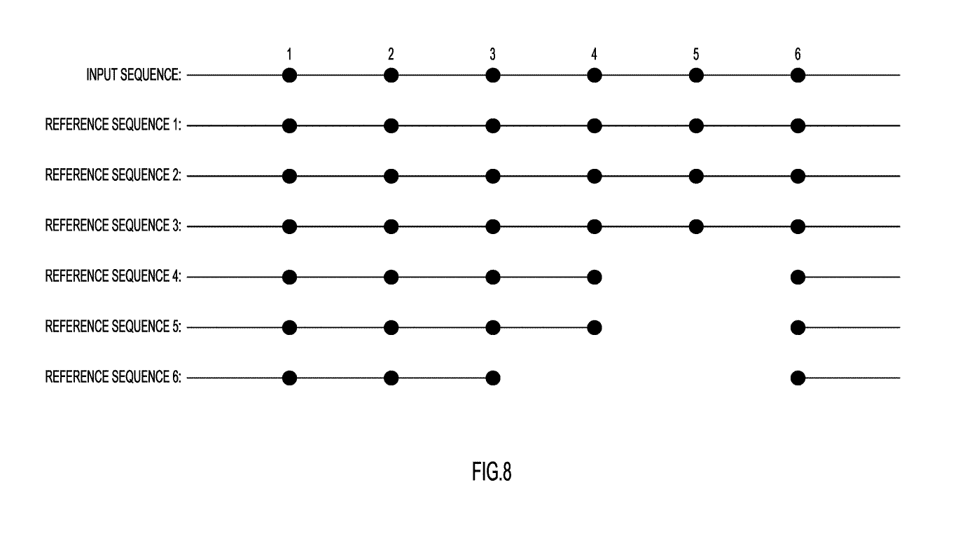

For an excursion in an input sequence, an aligned reference sequence may not have any feature vectors aligned to the excursion in the input sequence as described in FIG. 6. If a reference sequence does not have an aligned feature vector that is needed for computations at a step, then that reference sequence may not be used for that step. To clarify, an example will be used. FIG. 8 illustrates an input sequence and 6 reference sequences (all of the same class and denoted as class j) for step 1 to step 6. The first three reference sequences have a feature vector for each feature vector of the input sequence. Reference sequence 4 and reference sequence 5 do not have a feature vector that corresponds to the input feature vector at step 5. Reference sequence 6 does not have a feature vector that corresponds to the input feature vector at both step 4 and step 5.

Consider the computation of

$$\frac{{k}_{j , t} + 1}{{R}_{j} + 2} .$$

To account for excursions, this is changed to

$$\frac{{k}_{j , t} + 1}{{R}_{j , t} + 2} ,$$

where R_{j,t} indicates the number of reference sequences of class j that have a feature vector at step t. To compute k_{j,t} and R_{j,t}, we need, for each reference sequence of class j, a feature vector from step t. Accordingly, for steps 1-3 and 6 of FIG. 8, all six reference sequences have the needed feature vectors and R_{j,t} is six and k_{j,t} will be a number between zero and six. For step 4, five reference sequences have the needed feature vectors and R_{j,t} is five and k_{j,t} will be a number between zero and five. For step 5, three reference sequences have the needed feature vectors and R_{j,t} is three and k_{j,t} will be a number between zero and three.

Now consider the computation of

$$\frac{{K}_{j , t} + 1}{{K}_{j , t - 1} + 2} .$$

TO compute K_{j,t}, we need, for each reference sequence of class j, a feature vector from step t and a feature vector from step t−1. To compute k_{1,t-1} for class j, we need a feature vector from step t−1. These cannot be computed at step 1 since there is no previous step. At steps 2 and 3, K_{j,t} and k_{j,t-1} will each be between zero and six because all feature vectors are available. At step 4, K_{j,t} will be between 0 and 5 because reference sequence 6 does not have a feature vector at step 4, and k_{j,t-1} will be between 0 and 6 because all feature vectors are available at the previous step. At step 5, K_{j,t} will be between 0 and 3 because reference sequences 4-6 do not have feature vectors at step 5, and k_{j,t-1} will be between 0 and 5 because reference sequence 6 does not have a feature vector at the previous step. At step 6, K_{j,t} will be between 0 and 3 because reference sequences 4-6 do not have feature vectors at the previous step, and k_{j,t-1} will be between 0 and 3 for the same reason.

The same principles apply for the computation of

$$\frac{{K}_{i , t}^{M} + 1}{{K}_{i , t - 1}^{M - 1} + 2}$$

except that to compute K_{i,t}^{M}, feature vectors are needed for the current step and the M−1 previous steps. Accordingly, for larger values of M, a single missing feature vector will have a greater effect since it will reduce the number of available reference sequences for a total of M steps.

The determination of the radius of the n-sphere may also take into account the number of available reference feature vectors at a step. For example, instead of determining k using the total number of reference feature vectors, it may be determined by using the total number of available reference feature vectors at a step.

The above addresses an excursion in an input sequence. Where there is an excursion in a reference sequence, the feature vectors corresponding to the excursion may be removed during the alignment process. Where the feature vectors corresponding to an excursion in a reference sequence are not removed (e.g., alignment is not performed) these feature vectors may simply be ignored or passed over when implementing the techniques described above.

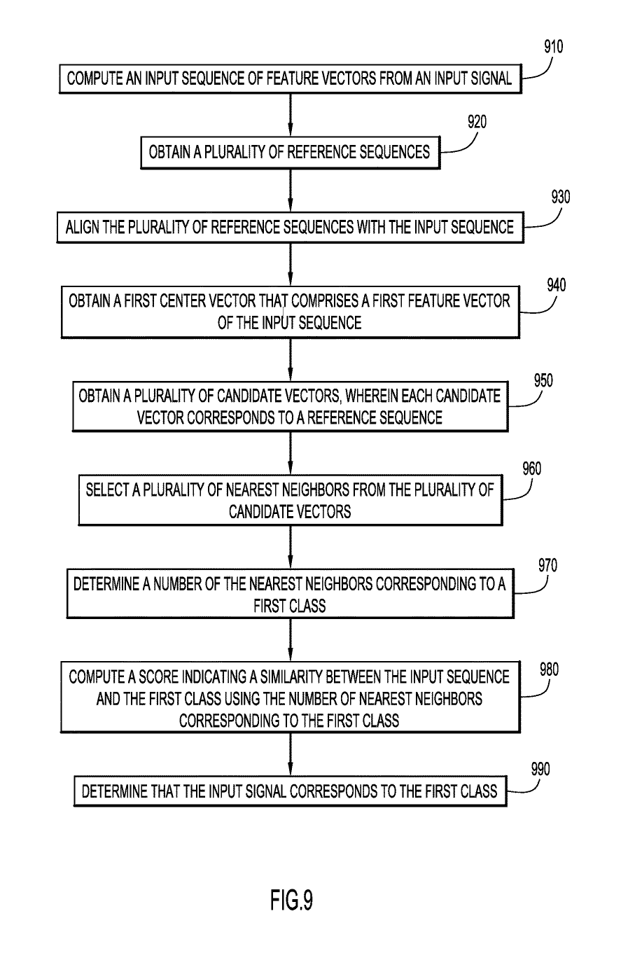

FIG. 9 is a flowchart illustrating an example implementation of classifying a signal using trajectories. In FIG. 9, the ordering of the blocks is exemplary and other orders are possible, not all blocks are required and, in some implementations, some blocks may be omitted or other blocks may be added. The processes of the flowcharts may be implemented, for example, by one or more computers, such as the computers described above.

At block 910, an input sequence of feature vectors is computed from an input signal. The input signal may be any type of signal that may be classified. For example, the input signal may be an audio signal, an image, or a video. The feature vectors may include any type of feature vectors that may be computed from the input signal, including but not limited to harmonic amplitudes or mel-frequency cepstral coefficients. The sequence may span any appropriate dimension. For an audio signal, the sequence may span time, and feature vectors may be computed at regular time intervals, such as every 10 milliseconds. In some implementations, a segmentation operation may be performed on the input signal or the input sequence as described above.

At block 920, a plurality of reference sequences is obtained. Each reference sequence may be a sequence of feature vectors, such as any of the types of sequences of feature vectors described above for the input sequence. Each reference sequence may correspond to a class of a plurality of classes. In some implementations, a segmentation operation may have been performed on the reference sequences as described above.

At block 930, each reference sequence of the plurality of reference sequences is aligned with the input sequence as described above. In some implementations, block 930 may not be performed and block 940 may follow block 920.

Blocks 940 to 980 may be performed for one or more steps of the input sequence.

At block 940, a first center vector is obtained for a first step of the input sequence. The first center vector may comprise the feature vector of the input sequence at the first step. In some implementations, the first center vector may also comprise other feature vectors of the input sequence as described above. For example, the first center vector may correspond to the feature vector of the input sequence from step t concatenated with the feature vector of the input sequence from step t−1.

At block 950, a plurality of candidate vectors is obtained. Each candidate vector may be computed from a reference sequence and may comprise the feature vector of the corresponding reference sequence from step t. In some implementations, each candidate vector may comprise additional feature vectors. For example, a candidate vector may correspond to the feature vector of a reference sequence from step t concatenated with the feature vector of that reference sequence from step t−1.

At block 960, a plurality of the candidate vectors is selected as nearest neighbors to the center vector. Any of the techniques describe above may be used to select the nearest neighbors. In some implementations, the nearest neighbors may consist of the k candidate vectors that are closest to the center vector according to some distance measure (e.g., Euclidean distance).

At block 970, a number of nearest neighbors that correspond to a first class is determined. For example, if there are 10 nearest neighbors, 8 of them may correspond to the first class and the other two may correspond to other classes. The number of nearest neighbors that correspond to other classes may also be determined. For example, if there are 10 nearest neighbors, 8 of them may correspond to the first class, 1 may correspond to a second class, and 1 may correspond to a third class. In some implementations, the number of nearest neighbors may correspond to K_{j,t}, as described above.

At block 980, a score is computed that indicates a similarity between the input sequence (or a portion of the input sequence that has been processed) and the first class. This score may be computed using any of the techniques described above. In some implementations, the score for the first step may be computed recursively using a score from the previous step. In some implementations, the score may be computed as Pr(ωⱼ|x₁, . . . , xₜ₋₁, xₜ) using any of the techniques described above (where the first class is ωⱼ and the first step is step t). Other scores may also be computed that indicate similarities between the input sequence and other classes.

Blocks 940 to 980 may be performed iteratively for any number of steps of the input sequence. In some implementations, blocks 940 to 980 are performed for each step of the input sequence.

At block 990, it is determined that the input signal corresponds to (e.g., best matches) the first class. In some implementations, the score from the final iteration of blocks 940 to 980 may be used to determine that the input signal corresponds to the first class. For example, after the final iteration of blocks 940 to 980, scores may be computed indicating a similarity between the input signal and each class of a plurality of classes, and the class having a highest score of the plurality of scores may be selected as the first class.

Depending on the implementation, blocks of any of the techniques described above may be performed in a different sequence, may be combined, may be split into multiple blocks, or may not be performed at all. The blocks may be performed by a general purpose computer, may be performed by a computer specialized for a particular application, may be performed by a single computer or processor, may be performed by multiple computers or processers, may be performed sequentially, or may be performed simultaneously.

The techniques described above may be implemented in hardware (e.g., field-programmable gate array (FPGA), application specific integrated circuit (ASIC)), in software, or a combination of hardware and software. The choice of implementing any portion of the above techniques in hardware or software may depend on the requirements of a particular implementation. A software module or program code may reside in volatile memory, non-volatile memory, RAM, flash memory, ROM, EPROM, or any other form of a non-transitory computer-readable storage medium.

Conditional language used herein, such as, “can,” “could,” “might,” “may,” “e.g.,” is intended to convey that certain implementations include, while other implementations do not include, certain features, elements and/or steps. Thus, such conditional language indicates that that features, elements and/or steps are not required for some implementations. The terms “comprising,” “including,” “having,” and the like are synonymous, used in an open-ended fashion, and do not exclude additional elements, features, acts, operations. The term “or” is used in its inclusive sense (and not in its exclusive sense) so that when used, for example, to connect a list of elements, the term “or” means one, some, or all of the elements in the list.

Conjunctive language such as the phrase “at least one of X, Y and Z,” unless specifically stated otherwise, is to be understood to convey that an item, term, etc. may be either X, Y or Z, or a combination thereof. Thus, such conjunctive language is not intended to imply that certain embodiments require at least one of X, at least one of Y and at least one of Z to each be present.

While the above detailed description has shown, described and pointed out novel features as applied to various implementations, it can be understood that various omissions, substitutions and changes in the form and details of the devices or techniques illustrated may be made without departing from the spirit of the disclosure. The scope of inventions disclosed herein is indicated by the appended claims rather than by the foregoing description. All changes which come within the meaning and range of equivalency of the claims are to be embraced within their scope.

What is claimed is:

1. A computer-implemented method for classifying an input signal, the method comprising:
computing an input sequence of feature vectors from the input signal;
obtaining a plurality of reference sequences, wherein each reference sequence of the plurality of reference sequences corresponds to a class of a plurality of classes, and wherein each reference sequence of the plurality of reference sequences comprises a sequence of feature vectors;
aligning the plurality of reference sequences with the input sequence;
for a first step of the input sequence:
obtaining a first center vector, the first center vector comprising a first feature vector of the input sequence,
obtaining a plurality of candidate vectors, each candidate vector corresponding to a reference sequence of the plurality of reference sequences and comprising a feature vector of the corresponding reference sequence,
selecting, from the plurality of candidate vectors, a plurality of nearest neighbors to the first center vector,
determining a number of the plurality of nearest neighbors corresponding to a first class, and
computing a first score indicating a similarity between the input signal and the first class using the number of the plurality of nearest neighbors corresponding to the first class; and
determining that the input signal corresponds to the first class using the first score.

2. The method of claim 1, wherein each feature vector of the input sequence of feature vector comprises a plurality of harmonic amplitudes.

3. The method of claim 1, wherein the input signal comprises speech and the first class corresponds to speech of a first speaker.

4. The method of claim 1, wherein the first center vector comprises a second feature vector of the input sequence, and wherein each candidate vector comprises a second feature vector of the corresponding reference sequence.

5. The method of claim 1, wherein selecting the plurality of nearest neighbors to the first center vector comprises selecting all candidate vectors within a multi-dimensional sphere centered on the first center vector.

6. The method of claim 1, wherein computing the first score comprises using a second score computed for a previous step of the input sequence.

7. The method of claim 1, further comprising:
for the first step of the input sequence:
determining a second number of the plurality of nearest neighbors corresponding to a second class, and
computing a second score indicating a similarity between the input signal and the second class using the number of the plurality of nearest neighbors corresponding to the second class; and
determining that the input signal corresponds to the first class further comprises using the second score.

8. The method of claim 1, further comprising:
for a second step of the input sequence:
obtaining a second center vector, the second center vector comprising a second feature vector of the input sequence,
obtaining a second plurality of candidate vectors, each candidate vector corresponding to a reference sequence of the plurality of reference sequences and comprising a feature vector of the reference sequence,
selecting, from the second plurality of candidate vectors, a second plurality of nearest neighbors to the second center vector, and
determining a second number of the plurality of nearest neighbors corresponding to the first class; and
wherein determining that the input signal corresponds to the first class further comprises using the second number.

9. A system for classifying an input signal, the system comprising one or more computing devices comprising at least one processor and at least one memory, the one or more computing devices configured to:
compute an input sequence of feature vectors from the input signal;
obtain a plurality of reference sequences, wherein each reference sequence of the plurality of reference sequences corresponds to a class of a plurality of classes, and wherein each reference sequence of the plurality of reference sequences comprises a sequence of feature vectors;
for a first step of the input sequence:
obtain a first center vector, the first center vector comprising a first feature vector of the input sequence,
obtain a plurality of candidate vectors, each candidate vector corresponding to a reference sequence of the plurality of reference sequences and comprising a feature vector of the corresponding reference sequence,
select, from the plurality of candidate vectors, a plurality of nearest neighbors to the first center vector,
determine a number of the plurality of nearest neighbors corresponding to a first class, and
compute a first score indicating a similarity between the input signal and the first class using the number of the plurality of nearest neighbors corresponding to the first class; and
determine that the input signal corresponds to the first class using the first score.

10. The system of claim 9, wherein the one or more computing devices are further configured to remove gaps from the input sequence.

11. The system of claim 9, wherein the one or more computing devices are further configured to align the plurality of reference sequences with the input sequence using an alignment graph.

12. The system of claim 9, wherein the one or more computing devices are further configured to compute the first score by computing a posterior probability using the number of the plurality of nearest neighbors corresponding to the first class.

13. The system of claim 9, wherein the one or more computing devices are further configured to select the plurality of nearest neighbors by selecting a number of candidate feature vectors that are closest to the first center vector according to a metric.

14. The system of claim 9 wherein the one or more computing devices are further configured to:
for the first step of the input sequence, determine a second number of the plurality of nearest neighbors corresponding to the first class at a previous step; and
compute the first score using the second number.

15. The system of claim 14, wherein the one or more computing devices are further configured to compute the first score by performing operations comprising:
computing a numerator by adding one to the number of the plurality of nearest neighbors corresponding to a first class;
computing a denominator by adding two to the second number of the plurality of nearest neighbors corresponding to the first class at the previous step; and
dividing the numerator by the denominator.

16. One or more non-transitory computer-readable media comprising computer executable instructions that, when executed, cause at least one processor to perform actions comprising:
computing an input sequence of feature vectors from an input signal;
obtaining a plurality of reference sequences, wherein:
each reference sequence comprises a sequence of feature vectors,
each reference sequence corresponds to a class of a plurality of classes,
the plurality of reference sequences comprises a first plurality of reference sequences corresponding to a first class, and
the plurality of reference sequences comprises a second plurality of reference sequences corresponding to a second class;
computing a first score indicating a match between the input sequence and the first class by comparing a trajectory of the input sequence with trajectories of the first plurality of input sequences in a multi-dimensional space;
computing a second score indicating a match between the input sequence and the second class by comparing the trajectory of the input sequence with trajectories of the second plurality of input sequences in a multi-dimensional space; and
determining that the input signal corresponds to the first class using the first score and the second score.

17. The one or more non-transitory computer-readable media of claim 16, wherein the first score corresponds to a first step of the input sequence, and the first score is computed using a third score corresponding to a previous step of the input sequence.

18. The one or more non-transitory computer-readable media of claim 16, wherein computing the first score comprises determining a number of reference sequences of the first plurality of reference sequences that are nearest neighbors to the input sequence at a step of the input sequence.

19. The one or more non-transitory computer-readable media of claim 18, wherein determining the number of reference sequences of the first plurality of reference sequences that are nearest neighbors to the input sequence at the step of the input sequence comprises:
computing an augmented input feature vector for the first step of the input sequence; and
computing an augmented reference feature vector for each reference sequence of the plurality of reference sequences.

20. The one or more non-transitory computer-readable media of claim 16, wherein computing the first score further comprises, for a first step of the input sequence:
obtaining a first center vector, the first center vector comprising a first feature vector of the input sequence;
obtaining a plurality of candidate vectors, each candidate vector corresponding to a reference sequence of the plurality of reference sequences and comprising a feature vector of the reference sequence;
selecting, from the plurality of candidate vectors, a plurality of nearest neighbors to the first center vector; and
determining a first number corresponding to a number of the plurality of nearest neighbors corresponding to the first class.
